(19) United States
(12) Patent Application Publication
(10) Pub. No.: US 2018/0329906 A1
(43) Pub. Date: Nov. 15, 2018

(54) SYSTEM AND METHOD FOR A WEB DATA EXTRACTOR TOOL

(71) Applicant: General Electric Company, Schenectady, NY (US)

(72) Inventors: Jason Anton Byers, Greenville, SC (US); Daniel Moss, Greenville, SC (US); Linda Carter, Greenville, SC (US); Brian Christopher Wheeler, Greenville, SC (US)

(21) Appl. No.: 15/590,549

(22) Filed: May 9, 2017

(51) Int. Cl. G06F 17/30; G06F 17/50; G06Q 10/08; G06F 3/0481; G06F 3/0482

(52) U.S. Cl. CPC G06F 17/30014; G06F 17/30861; G06F 17/5086; G06F 3/0482; G06F 17/30038; G06F 17/3005; G06F 3/04817; G06Q 10/0875

(57) ABSTRACT

A system includes a display, a database that may store multiple documentation relating to an industrial or machine part, and a processor. The processor may present a graphical user interface (GUI) on the display, and the GUI includes multiple input objects and an output object. The processor may also receive a reference code and at least one documentation type via the multiple input objects. Further, the processor may search the database for at least one documentation associated with the reference code and the at least one documentation type. In addition, the processor may retrieve the at least one documentation from the database. The processor may then display a visualization in the output object of the GUI, and the visualization includes a list of the at least one documentation retrieved from the database.

### BACKGROUND

The subject matter disclosed herein relates to a system for retrieving documented information relating to parts, such as industrial machine parts.

Industrial machines may include a large number of designed parts. Each part may have various documents that detail various data about the part. The documents may be stored in a database to allow access to the data. In some embodiments, an interface system may be provided through which the documents are accessed. It may be beneficial to improve the user's ability to access these documents via the database.

### BRIEF DESCRIPTION

Certain embodiments commensurate in scope with the original claims are summarized below. These embodiments are not intended to limit the scope of the claims, but rather these embodiments are intended only to provide a brief summary of possible forms of the systems and techniques described herein. Indeed, the presently disclosed embodiments may encompass a variety of forms that may be similar to or different from the embodiments set forth below.

In a first embodiment, a system includes a display, a database that may store multiple documentation relating to an industrial or machine part, and a processor. The processor may present a graphical user interface (GUI) on the display, and the GUI includes multiple input objects and an output object. The processor may also receive a reference code and at least one documentation type via the multiple input objects. Further, the processor may search the database for at least one documentation associated with the reference code and the at least one documentation type. In addition, the processor may retrieve the at least one documentation from the database. The processor may then display a visualization in the output object of the GUI, and the visualization includes a list of the at least one documentation retrieved from the database.

In a second embodiment, a method includes presenting, via a processor, a graphical user interface (GUI) on a display, and the GUI includes multiple input objects and an output object. The method also includes receiving, via the processor, a reference code and at least one documentation type via the multiple input objects. In addition, the method includes searching, via the processor, a database for at least one documentation associated with the reference code and the at least one documentation type, and the database may store multiple documentation relating to an industrial or machine part. Moreover, the method includes retrieving, via the processor, the at least one documentation from the database. Further, the method includes displaying, via the processor, a visualization in the output object of the GUI, and the visualization includes a list of the at least one documentation retrieved from the database.

In a third embodiment, a tangible, non-transitory, and computer-readable medium having instructions stored thereon that, when executed by one or more processors of a computer-aided design (CAD) system, may cause the one or more processors to present a graphical user interface (GUI) on a display, and the GUI includes multiple input objects and an output object. The instructions may also cause the one or more processors to receive a reference code and at least one documentation type via the multiple input objects. In addition, the medium may cause the one or more processors to search a database for at least one documentation associated with the reference code and the at least one documentation type, and the database may store multiple documentation relating to an industrial or machine part. Moreover, the medium may cause the one or more processors to retrieve the at least one documentation from the database. Further, the medium may cause the one or more processors to display a visualization in the output object of the GUI, and the visualization includes a list of the at least one documentation retrieved from the database.

### BRIEF DESCRIPTION OF THE DRAWINGS

These and other features, aspects, and advantages of the presently disclosed embodiments will become better understood when the following detailed description is read with reference to the accompanying drawings in which like characters represent like parts throughout the drawings, wherein:

FIG. 1 is a block diagram of an embodiment of a computer-aided technology (CAx) system, in accordance with an embodiment described herein;

FIG. 2 is a block diagram of embodiments of certain components of the CAx system of FIG., in accordance with an embodiment described herein;

FIG. 3 is a block diagram of an embodiment of a system that utilize a product life management (“PLM”) extractor to gather documents, in accordance with an embodiment described herein;

FIG. 4 is a flow chart illustrating an embodiment of a process to gather requested documents, in accordance with an embodiment described herein;

FIG. 5 is an embodiment of a graphical user interface (“GUI”) used to aid in gathering requested documents, in accordance with an embodiment described herein;

FIG. 6 is a flow chart illustrating an embodiment of a process to gather requested documents and identify pertinent information, in accordance with an embodiment described herein;

FIG. 7 is a first example of an embodiment of a GUI used to aid in gathering requested documents, in accordance with an embodiment described herein;

FIG. 8 is a second example of an embodiment of a GUI used to aid in gathering requested documents, in accordance with an embodiment described herein;

FIG. 9 is a third example of an embodiment of a GUI used to aid in gathering requested documents, in accordance with an embodiment described herein;

FIG. 10 is a fourth example of an embodiment of a GUI used to aid in gathering requested documents, in accordance with an embodiment described herein;

FIG. 11 is a fifth example of an embodiment of a GUI used to aid in gathering requested documents, in accordance with an embodiment described herein;

FIG. 12 is a sixth example of an embodiment of a GUI used to aid in gathering requested documents, in accordance with an embodiment described herein;

FIG. 13 is a seventh example of an embodiment of a GUI used to aid in gathering requested documents, in accordance with an embodiment described herein;

FIG. 14 is an eighth example of an embodiment of a GUI used to aid in gathering requested documents, in accordance with an embodiment described herein;

FIG. 15 is a ninth example of an embodiment of a GUI used to aid in gathering requested documents, in accordance with an embodiment described herein;

FIG. 16 is a tenth example of an embodiment of a GUI used to aid in gathering requested documents, in accordance with an embodiment described herein; and

FIG. 17 is an eleventh example of an embodiment of a GUI used to aid in gathering requested documents, in accordance with an embodiment described herein.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Computer-aided design (CAD) model systems may be used to design a machine or part of a machine. In addition to the design of the part of the machine, the CAD model systems may associate documentation of certain information for each part or machine. That is, documentation may be formed regarding the design, manufacture, sale, and distribution of the part. In some cases, this documentation may be stored in a database, such that one document or type of document may be accessed via the database at any given time. For example, to access a document relating to the manufacture of a part, a user may enter a reference code into a user interface capable of accessing the database for the part and a request for the particular document relating to the manufacture of the part. But, to access, for example, a document relating to the sale of the same part, the user may re-enter the reference code for the part and provide a separate request for the particular document relating to the sale of the part. In some instances, a user may want to access multiple documents related to a single part or multiple documents for multiple parts via a single request. Submitting separate requests for each document may become a time-consuming and inefficient manner in which to access documents. As such, in some embodiments, an extractor tool may be utilized to receive a reference number associated with a part from the user, search through a database that stores multiple types of documentation related to the part, and output the multiple types of requested documentation. Utilizing the extractor tool may save time and allow the user to more easily receive multiple documents.

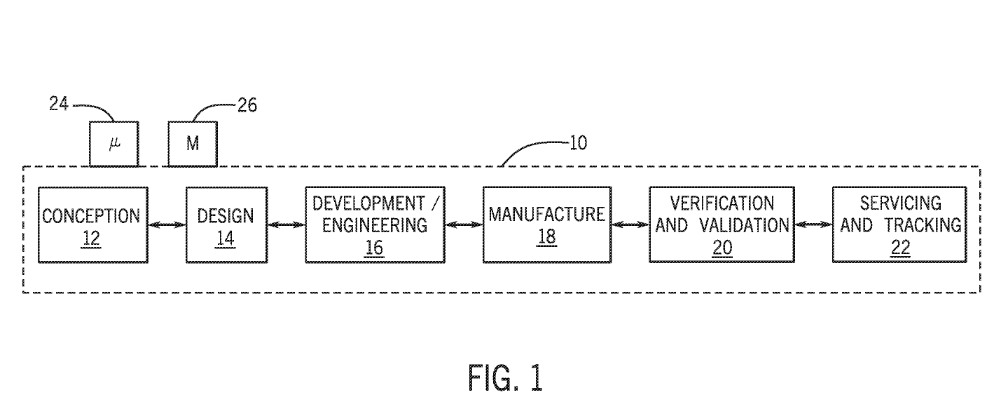

With the foregoing in mind, it may be useful to describe a computer-aided technologies (CAx) system that may incorporate the techniques described herein, for example to improve the generation of annotations on part drawings. Accordingly, FIG. 1 illustrates an embodiment of a CAx system 10 suitable for providing for a variety of processes, including product lifecycle management (PLM) processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machine). A series of design processes 14 may then use the specifications and/or prototype to produce, for example, one or more 3-dimensional (3D) design models of the part or product. The 3D design models may include solid/surface modeling, parametric models, wireframe models, vector models, non-uniform rational basis spline (NURBS) models, geometric models, 2-dimensional (2D) manufacturing part and assembly drawings, and the like.

Design models may then be further refined and added to via the execution of development/engineering processes 16. The development/engineering processes may, for example, create and apply models such as thermodynamic models, low cycle fatigue (LCF) life prediction models, multibody dynamics and kinematics models, computational fluid dynamics (CFD) models, finite element analysis (FEA) models, and/or 3-dimension to 2-dimension FEA mapping models that may be used to predict the behavior of the part or product during its operation. For example, turbine blades may be modeled to predict fluid flows, pressures, clearances, and the like, during operations of a gas turbine engine. The development/engineering processes 16 may additionally result in tolerances, materials specifications (e.g., material type, material hardness), clearance specifications, and the like.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. After the part is inspected, results from the CMM process may be automatically generated via an electronic Characteristic Accountability & Verification (eCAV) system.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be used by any other of the processes 12, 14, 16, 18, 20, 22 to improve the part or product or to create a new part or a new product. In this manner, the CAx system 10 may incorporate data from downstream processes and use the data to improve the part or to create a new part. Further, the data may be stored in a PLM system for ease of access.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

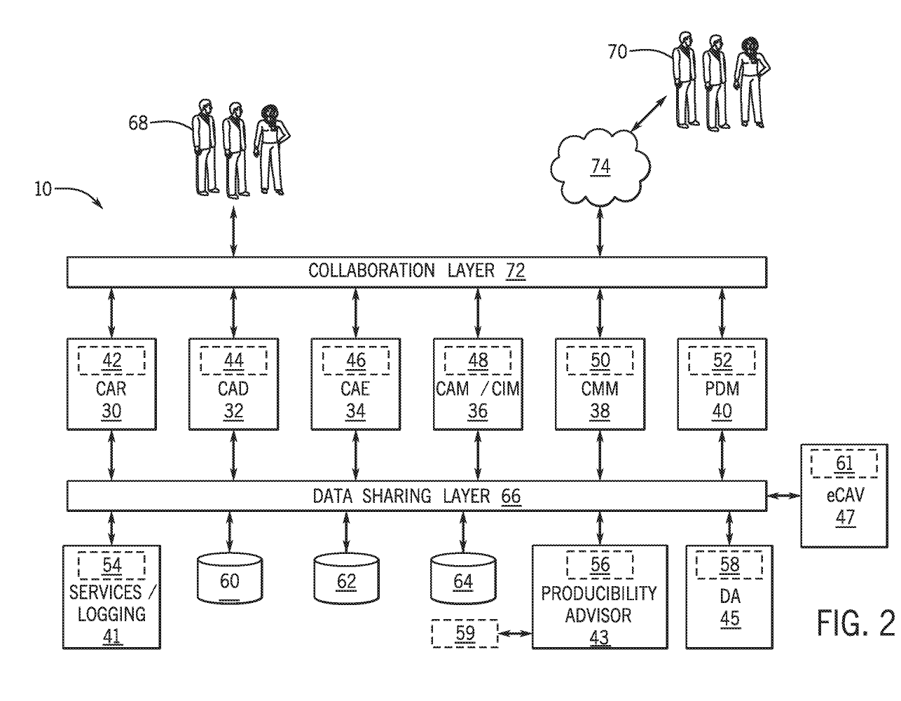

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40. Each of the systems 30, 32, 34, 36, 38 and 40 may be extensible and/or customizable, accordingly, each system 30 may include an extensibility and customization system 42, 44, 46, 48, 50, and 52, respectively. Additionally, each of the systems 30, 32, 34, 36, 38 and 40 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models, as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, callout, etc.). Indeed, the CAD system 32 may combine a graphical representation of the part or product with other, related information. Further, the CAD system 32 may adjust the annotations displayed on various drawings displaying multiple views and/or orientations of the same part, as discussed in detail in FIG. 4.

The CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics and kinematics models, computational fluid dynamics (CFD) models, finite element analysis (FEA) models, and/or 3-dimension to 2-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, and/or 38. For example, the systems 30, 32, 34, 36, and/or 38 may communicate with data repositories 56, 58, 60 via a data sharing layer 62. Further, the PDM system 40 may be a part of the PLM, and a system accessing the PDM system 40 may do so through the PLM. The PDM system 40 may then manage collaboration between the systems 30, 32, 34, 36, and/or 38 by providing for data translation services, versioning support, archive management, notices of updates, and so on. The PDM system 40 may additionally provide for business support such as interfacing with supplier/vendor systems and/or logistics systems for purchasing, invoicing, order tracking, and so on. The PDM system 40 may also interface with service/logging systems (e.g., service center data management systems) to aid in tracking the maintenance and life cycle of the part or product as it undergoes operations. Teams 64, 66 may collaborate with team members via a collaboration layer 68. The collaboration layer 68 may include web interfaces, messaging systems, file drop/pickup systems, and the like, suitable for sharing information and a variety of data. The collaboration layer 68 may also include cloud-based systems 70 or communicate with the cloud-based systems 70 that may provide for decentralized computing services and file storage. For example, portions (or all) of the systems 30, 32, 34, 36, 38 may be stored in the cloud 70 and/or accessible via the cloud 70.

The extensibility and customization systems 42, 44, 46, 48, 50, and 52 may provide for functionality not found natively in the CAR system 30, the CAD system 32, the CAM/CIM system 36, the CMM system 38 and/or the PDM system 40. For example, computer code or instructions may be added to the systems 30, 32, 34, 36, and/or 38 via shared libraries, modules, software subsystems and the like, included in the extensibility and customization systems 42, 44, 46, 48, 50, and/or 52. The extensibility and customization systems 42, 44, 46, 48, 50, and 52 may also use application programming interfaces (APIs) included in their respective systems 30, 32, 34, 36, and 38 to execute certain functions, objects, shared data, software systems, and so on, useful in extending the capabilities of the CAR system 30, the CAD system 32, the CAM/CIM system 36, the CMM system 38 and/or the PDM system 40. By enabling the processes 12, 14, 16, 18, 20, and 22, for example, via the systems 30, 32, 34, 36, and 38 and their respective extensibility and customization systems 42, 44, 46, 48, 50, and 52, the techniques described herein may provide for a more efficient “cradle-to-grave” product lifecycle management (PLM).

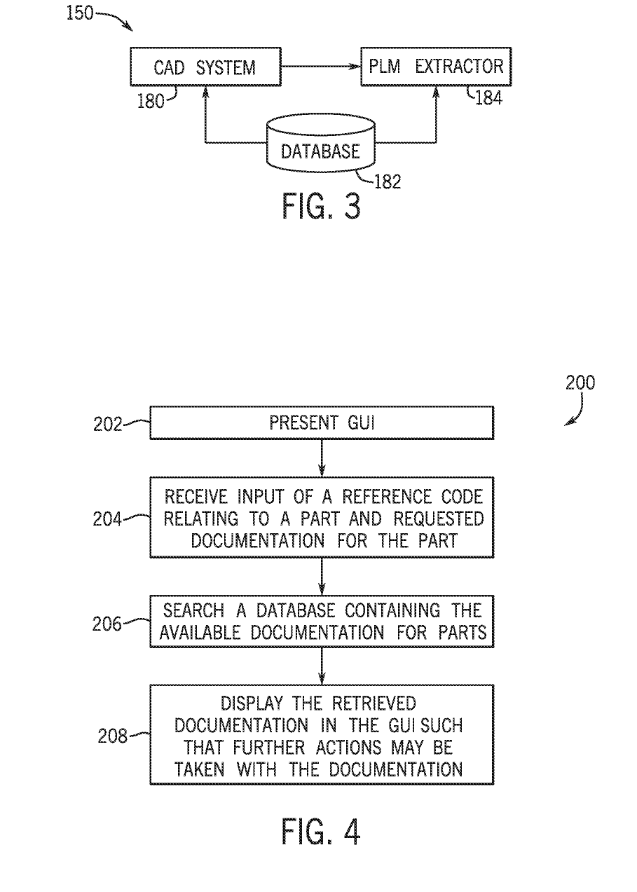

With the foregoing in mind, it should be understood that various documents and electronic files associated with the CAR system 30, the CAD system 32, the CAM/CIM system 36, the CMM system 38, and/or the PDM system 40 regarding various models, machines, parts, and the like may be stored data repositories 56, 58, 60 or other storage components. In some cases, the documentation produced during the PLM processes 12, 14, 16, 18, 20, and 22 may be stored on these storage components. As such, a system may be employed to provide access the documentation produced during the PLM processes 12, 14, 16, 18, 20, and 22. Accordingly, FIG. 3 is a block diagram of an embodiment of a system 150 that may access documented information of a part. Included in the system 150 is a CAD system 180 (e.g., the CAD system 32), a database 182, and a PLM database extractor 184. As discussed above, the CAD system 180 may provide 2D or 3D graphical representations of parts and may allow a user to manipulate the graphical representations to create models, drawings, reports, etc. The database 182 may store information that is accessible to either the CAD system 180, the PLM database extractor 184, or both. The database 182 (e.g., a server) may be located locally or separately from the CAD system 180 and the PLM database extractor 184. The database 182 may be accessible to multiple CAD systems 180 and PLM database extractors 184. The database 182 may store documented information produced during the PLM processes 12, 14, 16, 18, 20, and 22 (e.g., associated CAD files, engineering change order (“ECO”) information, bill of materials (“BOM”), routes of approval for the manufacture or sale of parts, product data definition reports (“PDDR”), product definitions, or com documents) relating to parts that may be used in various systems (e.g., gas turbines, engines, wind turbines, other power generation systems, etc.).

The PLM database extractor 184 may be a program that may be executable within the CAD system 180, or the PLM database extractor 184 may be executable separate from the CAD system 180. Further, the processor 24 may execute all of the functions of the PLM database extractor 184. The PLM database extractor 184 may allow a user to request multiple documents relating to multiple parts in one request. The PLM database extractor 184 may search the database 182 for the requested documents and aggregate the requested documents in one location (e.g., displayed in a graphical user interface (“GUI”)). By aggregating the requested documents in one place, the PLM database extractor 184 may allow a user to choose from various options on how to proceed with the information (e.g., downloading local copies, viewing, emailing, etc.).

FIG. 4 is a flow chart illustrating an embodiment of a process 200 to allow a user to retrieve available documented information of a part using a single request. Although the following process 200 describes a number of operations that may be performed, it should be noted that the process 200 may be performed in a variety of suitable orders, and each of the operations of the process 200 may not be performed.

When executed, the PLM database extractor 184 may present (block 202) a GUI that may facilitate operation of the PLM database extractor 184. The GUI may be presented on a display and may include user changeable options. The GUI may also include a section for receiving an input and a separate section for displaying an output. The section for receiving an input may include a hierarchy of types of documents that a user may navigate and input various data (e.g., reference codes, part numbers, desired documentation).

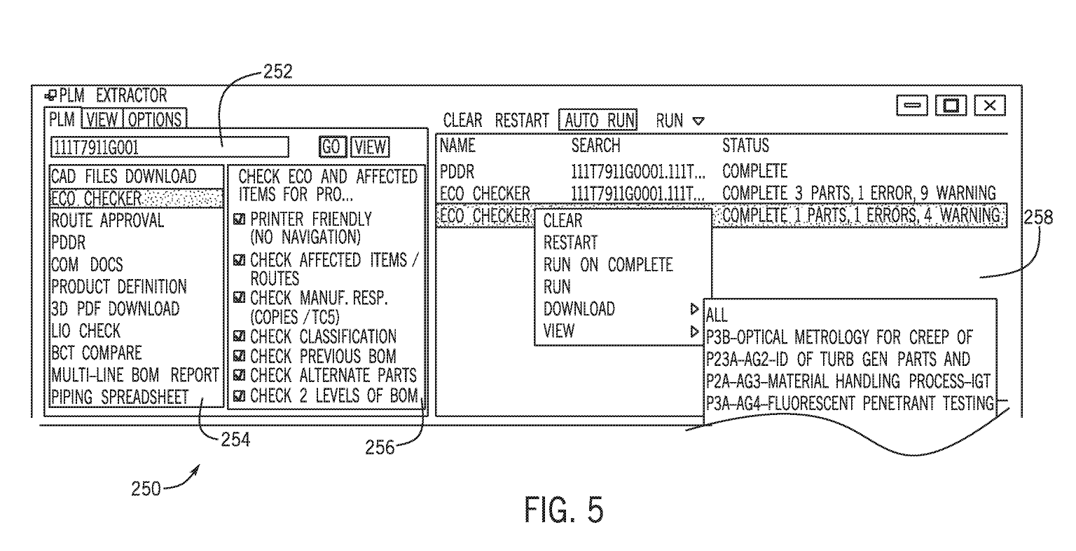

The PLM database extractor 184 may then receive (block 204) input a user. The input may include information (e.g., a username and password) that allows the PLM database extractor 184 to identify the user and determine the user's level of access based on the identity of the user. This allows the PLM database extractor 184 to check for the user's authority to access certain documentation. The input may also include information that indicates to the PLM database extractor 184 which documents are desired. For example, the input may include one or more reference codes for one or more parts and the input may include which types of documentation are requested. As will be detailed below with respect to FIG. 5, in some embodiments, the GUI may present a list of types of documents in a hierarchical format, such that the user may identify desired types of documentation.

After receiving input and indication to execute, the PLM database extractor 184 may search (block 206) a database (e.g., the database 182) for the available documentation. As discussed above, the database 182 may include the available documentation relating to the parts. The PLM database extractor 184 searches the database 182 for the requested documentation received (block 204) from the user. If the requested documentation is found in the database 182, the PLM database extractor 184 may retrieve the documentation so that the documentation may be output to a user.

Next, the PLM database extractor 184 may display (block 208) the retrieved documentation in the GUI. Depending on the type of documentation retrieved, the PLM database extractor 184 may allow a user to take further options with the retrieved documentation (e.g., downloading local copies, viewing, emailing, etc.), which is described in further detail below.

Keeping the process 200 in mind, FIG. 5 is a first example of an embodiment of a GUI 250 presented to the user after executing the PLM database extractor 184. The GUI 250 includes a text object 252 (e.g., an input object) where a user may enter an input (e.g., a reference code), as provided above with respect to block 204. The database 182 that stores the documentation produced during the PLM processes 12, 14, 16, 18, 20, and 22 may utilize a reference code for a part (e.g., a part number or any other combination of letters and numbers that may be utilized by the database 182) to identify the documentation related to the part. Further, an input in the text object 252 may include multiple reference codes. When entering multiple reference codes in the text object 252, the user may separate the reference code by a comma; however, alternative embodiments may utilize any symbol to separate the reference codes.

The GUI 250 further includes a display object 254 (e.g., an input object) that includes various types of documented information. The types of documented information may be displayed in a hierarchical manner and each type of documented information may include an associated title. For example, a higher level in the hierarchy may cover more types of documentation than a lower level in the hierarchy. The types of information displayed in the display object 254 may be a higher level type that covers multiple types of documents or a more specific type that covers a single type of document. For example, the title “ECO (”engineering change order“) Checker” allows a user to access multiple types of documents and the title “CAD Files Download” allows a user to access CAD files related to the reference number.

After a user has selected a title in the display object 254, further options, related to each title, are displayed in an expansion object 256 (e.g., an input object). In the depicted embodiment, the user has selected the title “ECO Checker” in the display object 254. In the present embodiment, seven options related to the title “ECO Checker” are displayed in the expansion object 256. Each option includes a selectable object, and a check mark is displayed in the selected object when the object is selected. The inputs entered in the text object 252, the display object 254, and the expansion object 256 are received (block 204) by the PLM database extractor 184. Further, the inputs indicate to the PLM database extractor 184 which documentation is requested. After a user has selected the options, the user may select the “Go” button. After receiving an indication that the “Go” button has been selected, the PLM database extractor 184 searches (block 206) the database 182 for the requested documentation relating to the selected options. The PLM database extractor 184 then retrieves the documentation and displays the results in an output object 258.

The PLM database extractor 184 allows a user to select options under multiple titles. For example, in the depicted embodiment, the user selected options under three different titles, the “ECO Checker,” the “LIO Check” and “Com docs.” LIO stands for line item owner and refers to a person who is responsible for ensuring designs of particular parts in an industrial machine adhere to particular guidelines. Com docs is short for common documents and refers to documents that may be shared across multiple parts. Accordingly, the PLM database extractor 184 searched (block 206) the database 182 for requested documentation under each title and displayed (block 208) the results in the output object 258 for each title. Further, the output object 258 also displays the associated part number and a status. The status displays information regarding whether the PLM database extractor 184 has completed a search associated with the title or if the PLM database extractor 184 is still in process of completing the search. The status may also include different information for each title, as illustrated in the present embodiment. For example, next to the title “ECO Checker,” the output object 258 displays “1 parts, 1 errors, 4 warnings,” and next to the title “LIO Check,” the output object 258 displays “2 dwgs, 1 ref docs.”

The GUI 250 also includes several selectable options displayed above the output object 258. The “Clear” option allows a user to remove the results displayed in the output object 258. For example, if the user selects the “Clear” option, the three results in the output object 258 would be removed. The “Restart” option allows a user to restart the PLM database extractor 184 if it is in the process of completing a search. The “Auto Run” option is a selectable option. If selected, this feature automatically runs tasks upon the user selecting a title. The “Run” option allows the user to run the task associated with currently selected title. The “Run” option also includes a drop down object that allows the user to a task associated with a title that is not currently selected.

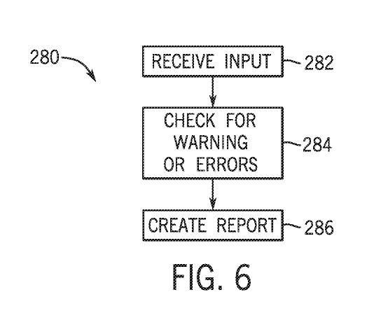

FIG. 6 is a flow chart illustrating an embodiment of a process 280 to check for errors or warnings in the ECO. Although the following process 280 describes a number of operations that may be performed, it should be noted that the process 280 may be performed in a variety of suitable orders. All of the operations of the process 280 may not be performed.

Some documentation in the database 182 may include warning or error indications associated with certain pieces of information within the documentation. For example, a warning may indicate an issue with the associated information. Using the following process, the PLM database extractor 184 may search for warning or error indications and display the findings in the output object 258.

The PLM database extractor 184 receives (block 282) an input, such as that discussed above with respect to block 202. For instance, under the “ECO Checker” title, the user selects various options, as discussed above. In the present embodiment, documentation relating to the title “ECO Checker” may include searchable warning and error indications. It should be appreciated, that in alternative embodiments, other titles may also include searchable warning or error indication.

Based on the options selected, the PLM database extractor 184 may search (block 284) the database 182 for warnings or errors associated with each of the requested documents selected by the user, in accordance with process 200. For example, the PLM database extractor 184 may search the database 182 utilizing key words, or the documentation in the database 182 may include an indication that a warning or error is contained within the respective document.

In particular, the PLM database extractor 184 may determine whether a warning or error is contained within a document. For example, the PLM database extractor 184 may compare each of the values found in the document, with values expected to be in the document. If the actual values do not match or are outside an acceptable range of expected values, then the PLM database extractor 184 may find that a warning or error is contained within the respective document. In another embodiment, the PLM database extractor 184 may find that a warning or error is contained within a document if an unexpected change has been made to the document. Each document may include information relating to a set of users expected to make changes and a time period during which each change may be made to the document. If a user outside the expected set of users makes a change or a change is made at a time outside of the expected time period, then the PLM database extractor 184 may find a waring or error is contained within the respective document.

Next, the PLM database extractor 184 creates (block 286) a report (e.g., an html or text file) detailing any found warnings or errors. For example, the report may indicate whether an item is a warning or error, and may indicate which specific piece of information within a document is associated with the warning or error. The created report may also include hyperlinks to the location of the documents (e.g., the BOM, specifications, materials, reference documents, manufacturing responsibilities, classifications, or alternate parts) in the PLM. The report may also include icons that indicate a warning or error next to any document that includes an error. Further, as discussed previously, a brief summary of the number of warnings and errors found may be displayed in the output object 258, as shown in FIG. 5.

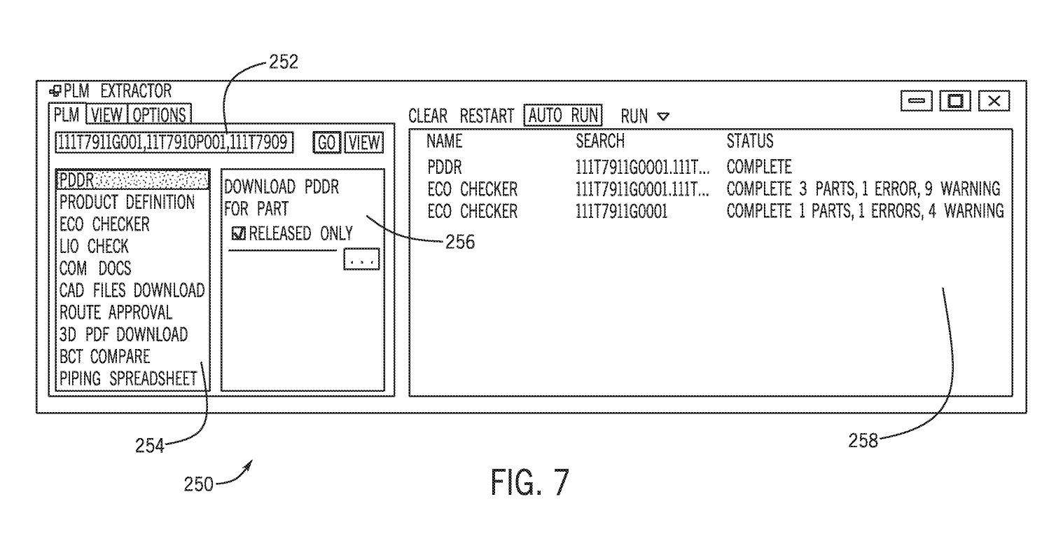

FIGS. 7-17 highlight the different example options available under the different titles displayed in the display object 254. FIG. 7 illustrates the options in the expansion object 256 after a user has selected the title “PDDR” (“product data definition report”) in the display object 254. The user may select the “Released Only” option, or the user may enter an input in the text object. In the present embodiment, documents in the database 182 include information relating to whether the document has been approved. If a document has been approved, then the document will include information indicating that it has been released. Selecting the “Released Only” option causes the PLM database extractor 184 to search for documents that have been released and not selecting the “Released Only” option causes the PLM database extractor to search for all documents, even if the document has not been released. After receiving an input that corresponds to the “PDDR” title, the PLM database extractor 184 searches the database 182 for the PDDR for the input reference code. The “Options” tab allows a user to selectively load the files found by the PLM database extractor 184. The “Options” tab also includes a selectable object that allows a user to select a default file location for files downloaded by the PLM database extractor 184. Then, the PLM database extractor 184 may download the PDDR to a file location preselected under the “Options” tab or the “. . . ” text object.

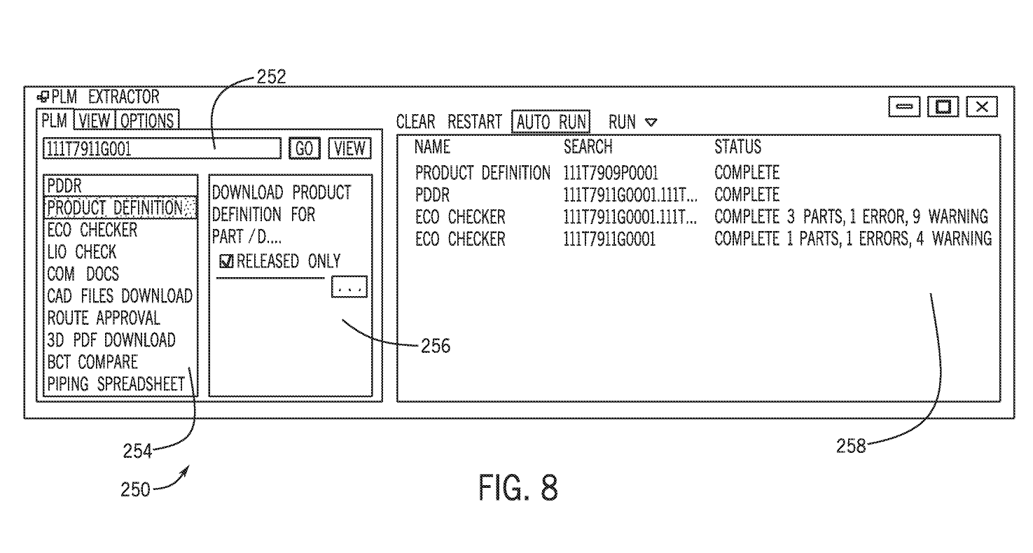

FIG. 8 illustrates the options in the expansion object 256 after a user has selected the title “Product Definition” in the display object 254. The user may select the “Released Only” option, or the user may enter an input in the text object. After receiving an input that corresponds to the “Product Definition” title, the PLM database extractor 184 searches the database 182 for three-dimensional or two-dimensional PDF files associated with the input reference code. Then, the PLM database extractor 184 downloads the PDF files to a file location preselected in the “Options” tab by the user or the “. . . ” text object.

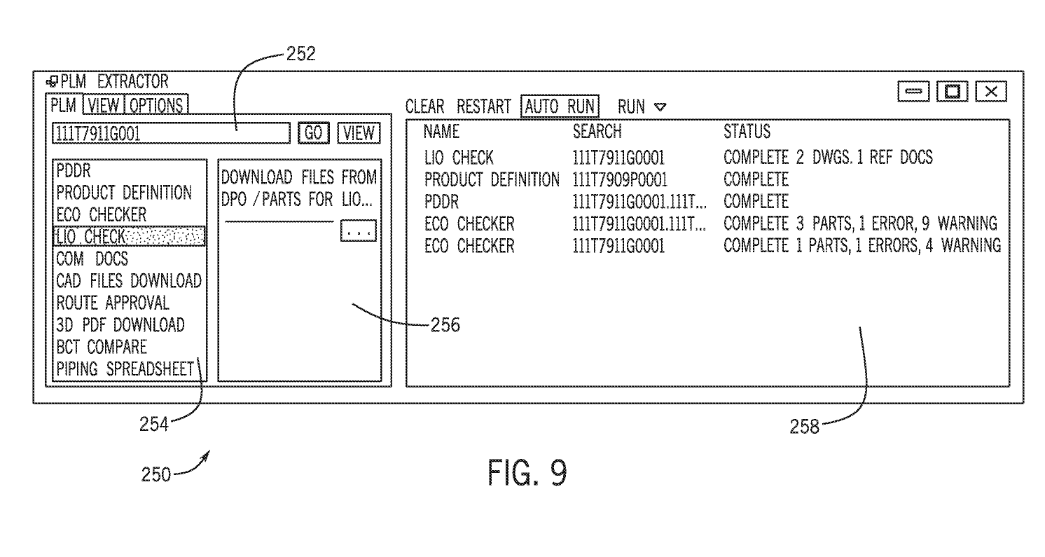

FIG. 9 depicts the options in the expansion object 256 after a user has selected the title “LIO Check” in the display object 254. The user may enter an input by selecting the object with the text object “. . . ”. Selecting this object allows the user to navigate through a file explorer to select a file location for files to be downloaded by the PLM database extractor 184. This file location may be the same or different from the one selected in the “Options” tab. After executing, the PLM database extractor 184 searches through the database 182 to find objects associated with the input reference code. Then, the PLM database extractor 184 creates a report (e.g., a text or excel document) of similar parts used in any application. The created report notes the differences between the current reference code and the similar parts.

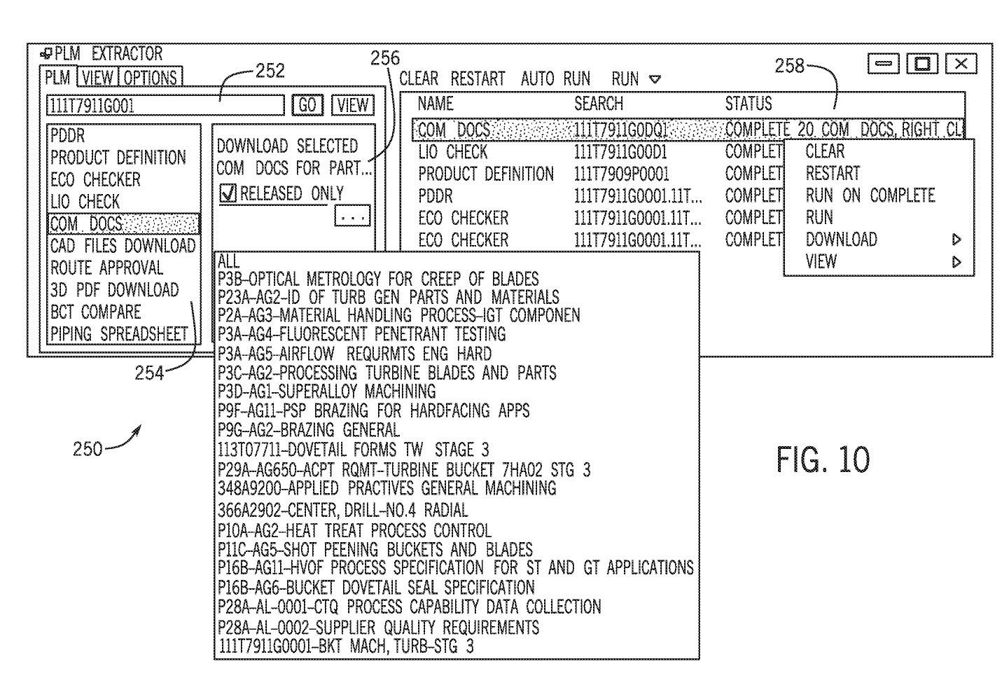

FIG. 10 depicts the options in the expansion object 256 where the user has selected the title “Com Docs” in the display object 254. The user may select the “Released Only” option, or the user may enter an input in the text object. After executing the title “Com Docs”, the PLM database extractor 184 searches the database 182 for the com docs associated with the reference code. Then, the PLM database extractor 184 displays how many com docs were found in the output object 258. Selecting the “Com Docs” in the output object 258 opens a list of all of the com docs found, and each item in the list may include a reference code and a title associated with the reference code. Further, selecting the “Com Docs” may allow a user to either download or view some or all of the com docs found by the PLM database extractor 184.

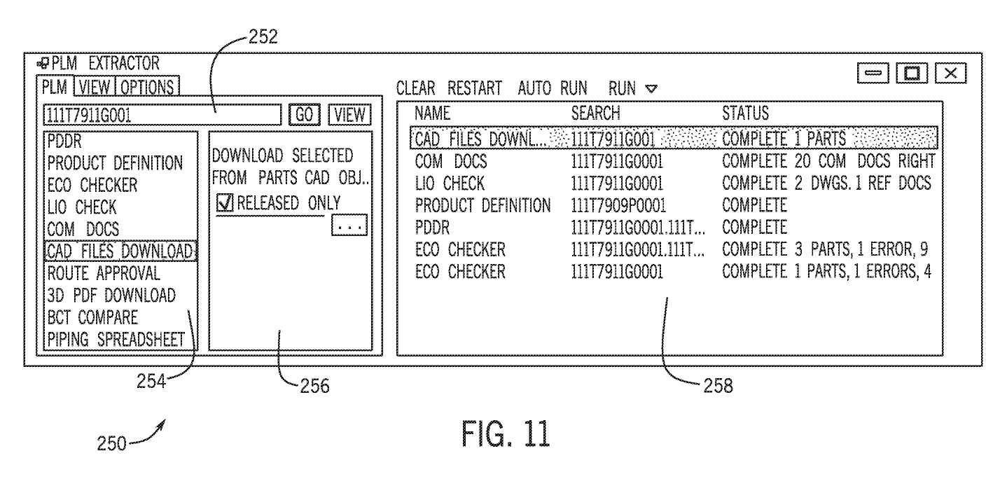

FIG. 11 illustrates the options in the expansion object 256 where the user has selected the title “CAD Files Download” in the display object 254. The user may select the “Released Only” option, or the user may enter an input in the text object. After executing the “CAD Files Download” title, the PLM database extractor 184 searches the database 182 for drawings and models associated with the input reference code. The drawings and models may include top level drawing or models (i.e., an assembly that includes multiple parts), children drawings or models (i.e., one part of an assembly that includes multiple parts), or both. Then, the PLM database extractor 184 may download or make available for download the drawing and model files to a file location preselected in the “Options” tab. In embodiments where the PLM database extractor 184 makes the drawing and model available for download, the “CAD Files Download” may be selected in the output object 158, where an option to download may be available.

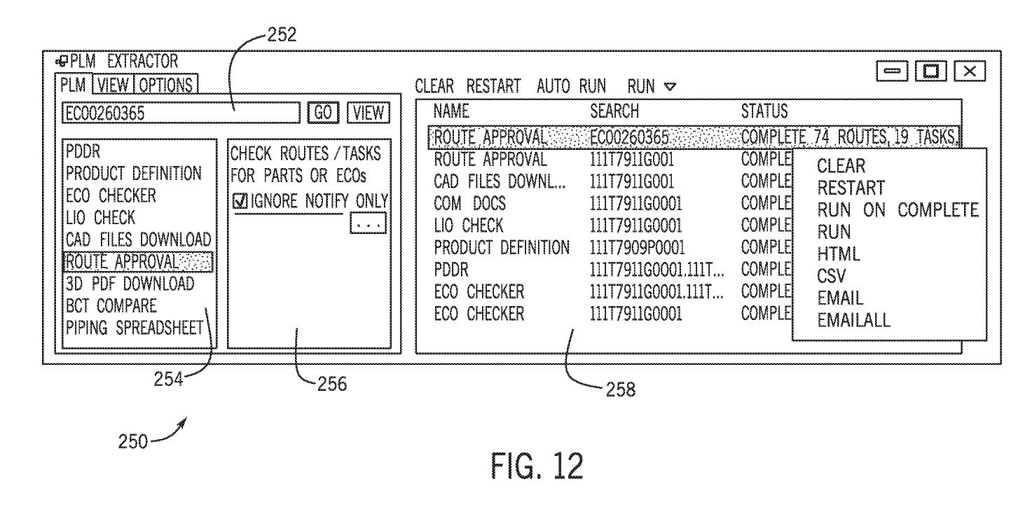

FIG. 12 depicts the options in the expansion object 256 where the user has selected the title “Route Approval” in the display object 254. When a part is going through steps of manufacture or sale, each step may need approval from someone with authority to approve the respective step. Each step may be interpreted as a route. For example, the steps may include any step in the process of designing, manufacturing, or shipping a part. Some routes may require approval to move onto the next route and some routes may notify an appropriate person that the route is taking place. When the “Ignore notify only” option is selected, the PLM database extractor 184 may exclude from a search routes that may notify an appropriate person that the route is taking place. When executing the “Route Approval” title, the PLM database extractor 184 checks the routes available in the database 182 using either a reference code or an ECO number, as shown in the text object 252. After executing, the PLM database extractor 184 checks the database 182 for routes associated with the reference code or ECO number and outputs a downloadable report in the output object 258. The report details the status of each route, giving information relating to who approved the route, whether the route has been approved, and any additional comments included on the route. The user may download the report in the form of an HTML file or a CSV file by right-clicking on the “Route Approval” option in the output object 258. Further, the user may email some or all of people who have yet to approve a route using an option object that appears when the user right-clicks on the “Route Approval” option in the output object 258.

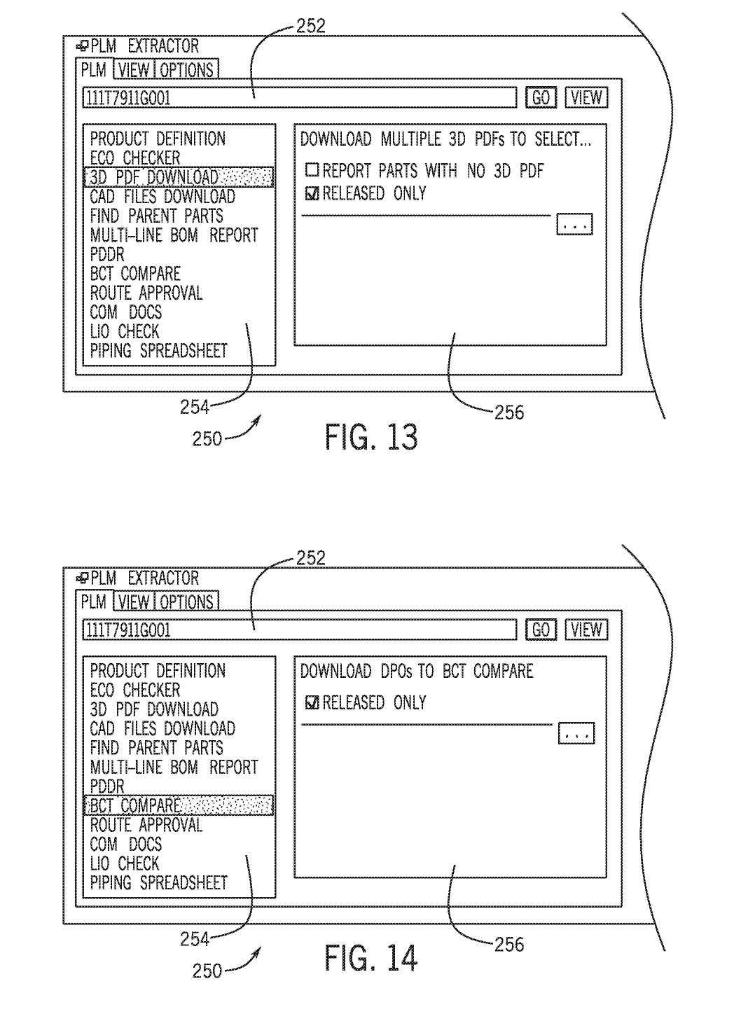

FIG. 13 illustrates the options in the expansion object 256 after a user has selected the title “3D PDF Download” in the display object 254. In the expansion object 256, the user may select the “Released Only” option, or the user may enter an input in the text object. Further, the user may selection the “Report Parts with no 3D PDF” option, which causes the PLM database extractor 184 to display parts for which no 3D PDF is found. After receiving an input that corresponds to the “3D PDF Download” title, the PLM database extractor 184 searches the database 182 for 3D PDF files associated with the input reference code in the text object 252. Then, the PLM database extractor 184 downloads the 3D PDF files to the file location preselected in the “Options” tab or the “. . . ” text object.

FIG. 14 depicts the options in the expansion object 256 after a user has selected the title “BCT Compare” in the display object 254. In the expansion object 256, the user may select the “Released Only” option, or the user may enter an input in the text object. After receiving an input that corresponds to the “BCT Compare” title, the PLM database extractor 184 searches the database 182 for drawing print objects (DPOs, e.g., 2D PDFs of drawings) associated with the input reference code in the text object 252. Then, the PLM database extractor 184 executes a BCT compare on the DPOs found by the PLM database extractor 184. The BCT compare is a tool that may compare DPOs and create a file (e.g., a text or excel file) that includes a list of all of the similarities and differences between the DPOs. Then, the PLM database extractor 184 downloads the file output by BCT compare tool to the file location preselected in the “Options” tab or the “. . . ” text object.

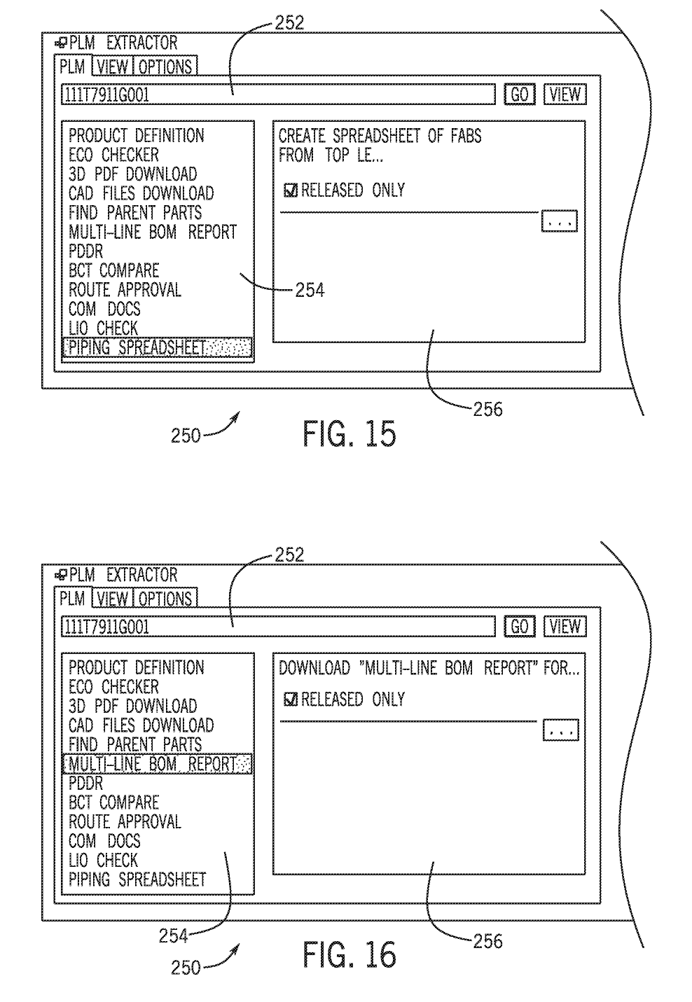

FIG. 15 shows the options in the expansion object 256 after a user has selected the title “Piping Spreadsheet” in the display object 254. In the expansion object 256, the user may select the “Released Only” option, or the user may enter an input in the text object. After receiving an input that corresponds to the “Piping Spreadsheet” title, the PLM database extractor 184 searches the database 182 for piping assemblies associated with the input reference code in the text object 252. Then, the PLM database extractor 184 executes a piping spreadsheet tool on the piping assemblies found by the PLM database extractor 184. The piping assemblies may include parts that are at higher (e.g., parent) and lower (e.g., child) levels relative to each other. The piping spreadsheet tool may iterate through each of the piping assemblies to determine which level each part corresponds to and which parent part each child part corresponds to. For example, the input reference code may relate to a part that has multiple parts at a lower level that are considered its children. The piping spreadsheet tool may then create a spreadsheet (e.g., an excel file) that displays the part that relates to the input reference code and all of its children parts in a multi-level list. Then, the PLM database extractor 184 downloads the file output by piping spreadsheet tool compare tool to the file location preselected in the “Options” tab or the “. . . ” text object.

FIG. 16 depicts the options in the expansion object 256 after a user has selected the title “Multi-Line BOM Report” in the display object 254. In the expansion object 256, the user may select the “Released Only” option, or the user may enter an input in the text object. After receiving an input that corresponds to the “Multi-Line BOM Report” title, the PLM database extractor 184 searches the database 182 for the bill of materials (BOM) associated with the input reference code in the text object 252. Then, the PLM database extractor 184 downloads the BOM (e.g., an excel file) to the file location preselected in the “Options” tab or the “. . . ” text object.

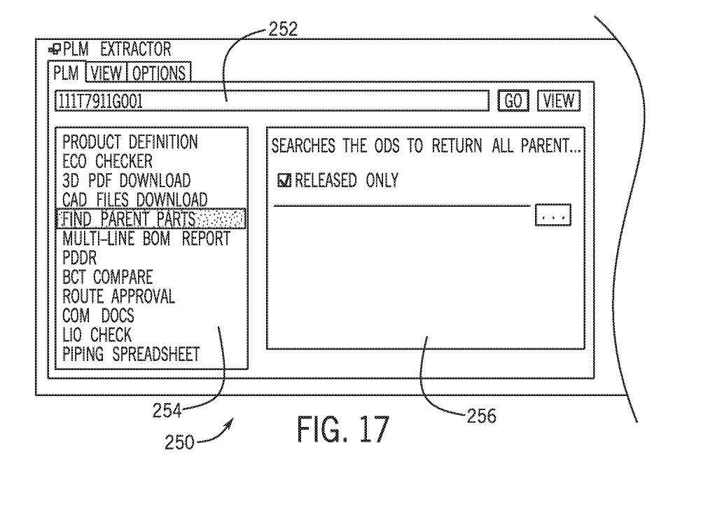

FIG. 17 illustrates the options in the expansion object 256 after a user has selected the title “Find Parent Parts” in the display object 254. In the expansion object 256, the user may select the “Released Only” option, or the user may enter an input in the text object. As discussed above, the input reference code may relate to a part that may be considered either a parent part or a child part. Further, the part may be a child to multiple parent parts. After receiving an input that corresponds to the “Find Parent Parts” title, the PLM database extractor 184 searches the database 182 the parts that are considered the parent parts of the part associated with the input reference code in the text object 252. Then, the PLM database extractor 184 downloads the found parent parts, either as a list (e.g., a text or excel file) or as 3D cad models, to the file location preselected in the “Options” tab or the “. . . ” text object.

This written description uses examples of the presently disclosed embodiments, including the best mode, and also to enable any person skilled in the art to practice the disclosed embodiments, including making and using any devices or systems and performing any incorporated methods. The patentable scope of the disclosed embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a display;
a database configured to store a plurality of documentation relating to an industrial or machine part;
a processor configured to:
present a graphical user interface (GUI) on the display, wherein the GUI comprises a plurality of input objects and an output object;
receive a reference code and at least one documentation type via the plurality of input objects;
search the database for at least one documentation associated with the reference code and the at least one documentation type;
retrieve the at least one documentation from the database; and
display a visualization in the output object of the GUI, wherein the visualization comprises a list of the at least one documentation retrieved from the database.

2. The system of claim 1, wherein the processor is configured to search the database for one or more documents comprising one or more warnings or errors related to the reference code when the processor searches the database.

3. The system of claim 2, wherein the processor is configured to generate a report comprising the one or more warnings or errors found when the processor checks the database.

4. The system of claim 3, wherein the report comprises an icon to indicate each of the one or more warnings or errors and one or more hyperlinks configured to access a location in the database comprising the documentation associated with a respective warning or error.

5. The system of claim 1, wherein the processor is configured to automatically download the at least one documentation retrieved from the database to a predetermined location.

6. The system of claim 1, wherein the processor is configured to display the at least one documentation or download the at least one documentation retrieved from the database based on a user input.

7. The system of claim 1, wherein the processor is configured to:
search the database for a plurality of routes related to the reference code and whether each of the plurality of routes has been approved;
search for a quantity of a total number of the plurality of routes related to the reference code; and
display the quantity of the total number of the plurality of routes and a quantity of the plurality of routes that has not been approved.

8. The system of claim 7, wherein the processor is configured to check the plurality of routes for approval, and, if one of the plurality of routes has not been approved, transmit an email requesting approval of the one of the plurality of routes.

9. The system of claim 7, wherein the processor is configured to generate a report comprising the plurality of routes, and the report is indicative of a person that has authority to approve a respective one of the plurality of routes, the reference code, and whether each of the plurality of routes has been approved.

10. A method comprising:
presenting, via a processor, a graphical user interface (GUI) on a display, wherein the GUI comprises a plurality of input objects and an output object;
receiving, via the processor, a reference code and at least one documentation type via the plurality of input objects;
searching, via the processor, a database for at least one documentation associated with the reference code and the at least one documentation type, wherein the database is configured to store a plurality of documentation relating to an industrial or machine part;
retrieving, via the processor, the at least one documentation from the database; and
displaying, via the processor, a visualization in the output object of the GUI, wherein the visualization comprises a list of the at least documentation retrieved from the database.

11. The method of claim 10, comprising searching, via the processor, the database for one or more documents comprising one or more warnings or errors related to the reference code when the processor searches the database.

12. The method of claim 11, comprising generating, via the processor, a report comprising the one or more warnings or errors found when the processor checks the database.

13. The method of claim 10, comprising automatically downloading, via the processor, the at least one documentation retrieved from the database based on a user input.

14. The method of claim 10, comprising:
searching, via the processor, the database for a plurality of routes related to the reference code and whether each of the plurality of routes has been approved;
searching, via the processor, for a quantity of a total number of the plurality of routes related to the reference code; and
displaying, via the processor, the quantity of the total number of the plurality of routes and a quantity of the plurality of routes that has not been approved.

15. The method of claim 14, comprising generating, via the processor, a report comprising the plurality of routes, and the report is indicative of a person that has authority to approve a respective one of the plurality of routes, the reference code, and whether each of the plurality of routes has been approved.

16. A tangible, non-transitory, and computer-readable medium having instructions stored thereon that, when executed by one or more processors of a computer-aided design (CAD) system, are configured to cause the one or more processors to:
present a graphical user interface (GUI) on a display, wherein the GUI comprises a plurality of input objects and an output object;
receive a reference code and at least one documentation type via the plurality of input objects;
search a database for at least one documentation associated with the reference code and the at least one documentation type, wherein the database is configured to store a plurality of documentation relating to an industrial or machine part;
retrieve the at least one documentation from the database; and
display a visualization in the output object of the GUI, wherein the visualization comprises a list of the at least documentation retrieved from the database.

17. The tangible, non-transitory, and computer-readable medium of claim 16, wherein the instructions are configured to cause the one or more processors to search the database for one or more documents comprising one or more warnings or errors related to the reference code when the processor searches the database.

18. The tangible, non-transitory, and computer-readable medium of claim 17, wherein the instructions are configured to cause the one or more processors to generate a report comprising the one or more warnings or errors found when the processor checks the database.

19. The tangible, non-transitory, and computer-readable medium of claim 16, wherein the instructions are configured to cause the one or more processors to:
search the database for a plurality of routes related to the reference code and whether each of the plurality of routes has been approved;
search for a quantity of a total number of the plurality of routes related to the reference code; and
display the quantity of the total number of the plurality of routes and a quantity of the plurality of routes that has not been approved.

20. The tangible, non-transitory, and computer-readable medium of claim 19, wherein the instructions are configured to cause the one or more processors to generate a report comprising the plurality of routes, and the report is indicative of a person that has authority to approve a respective one of the plurality of routes, the reference code, and whether each of the plurality of routes has been approved.
